(19) United States
(12) Patent Application Publication
(10) Pub. No.: US 2026/0008881 A1
(43) Pub. Date: Jan. 8, 2026

(54) TERNARY DIBLOCK COPOLYMER, ACTIVE CATIONIC POLYMERIZATION INITIATOR COMPOSITION, DIISOPROPENYLBENZENE COPOLYMER, TERPENE POLYMER, FLAME-RETARDANT RESIN COMPOSITION, FLAME-RETARDANT RESIN CURED PRODUCT AND USES THEREOF

(71) Applicant: CHIN YEE CHEMICAL INDUSTRIES CO.,LTD., TAIPEI (TW)

(72) Inventor: Pi-Tao Kuo, Taipei (TW)

(73) Assignee: CHIN YEE CHEMICAL INDUSTRIES CO.,LTD., TAIPEI (TW)

(21) Appl. No.: 18/800,137

(22) Filed: Aug. 12, 2024

(30) Foreign Application Priority Data
Jul. 5, 2024 (TW) 113125363

(51) Int. Cl. C08F 297/08; C08J 5/18; C08K 5/50; C08K 5/5397

(52) U.S. Cl. CPC C08F 297/086; C08J 5/18; C08K 5/50; C08K 5/5397; C08J 2353/00

(57) ABSTRACT

The disclosure provides an active cationic polymerization initiator composition for synthesizing a ternary diblock copolymer, a diisopropenylbenzene copolymer and a terpene polymer. The disclosure further provides a flame-retardant resin composition, which includes: (a) a hydrocarbon resin; and (b) a reactive flame-retardant, and may optionally include a modified polyphenylene ether. A flame-retardant resin cured product formed from the flame-retardant resin composition may have high heat resistance, low dielectric constant, low dissipation factor, flame retardancy and/or film-forming properties, and is suitable for uses in fabrication of a semiconductor packaging material, a substrate and the like for the high-speed and high-frequency field.

### CROSS-REFERENCE TO RELATED APPLICATION

This application claims the priority benefit of Taiwan application serial no. 113125363, filed on Jul. 5, 2024. The entirety of the above-mentioned patent application is hereby incorporated by reference herein and made a part of this specification.

### BACKGROUND

### Technical Field

The disclosure provides an active cationic polymerization initiator composition, a ternary diblock copolymer, a diisopropenylbenzene copolymer and a terpene polymer synthesized thereby, a flame-retardant resin composition including the ternary diblock copolymer, the diisopropenylbenzene copolymer or the terpene polymer, a flame-retardant resin cured product of the flame-retardant resin composition, and a use of the flame-retardant resin cured product.

### Description of Related Art

In 1984, Higashimura and Sawamoto achieved active cationic polymerization of alkyl vinyl ethers by utilizing a protic acid as the ion source in conjunction with a Lewis acid initiator. In the active cationic polymerization, the introduction of the Lewis acid into a carbocation system generates a weakly equilibrated carbocation. This equilibrium favors a dormant state. The subsequent addition of a weak nucleophile may further reduce the concentration of active matter. This system activates the dormant state in a reversible and intermittent manner, thereby extending the lifespan of the growing carbocation. This theory became the focus of future research on active cationic polymerization.

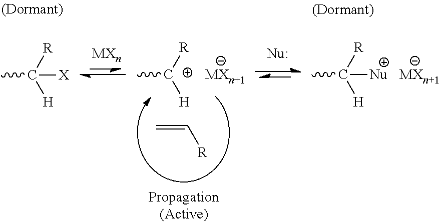

After the 1950s, people were keen to study the cationic polymerization of terpenes. However, this research only yielded polymers with low glass transition temperatures and low molecular weights. Due to the relatively low molecular weight of these terpene polymers, their commercial applications were limited to uses as adhesives and polymer modifiers. In recent years, the discovery of cyclic olefin polymers (COPs) and cyclic olefin copolymers (COCs) has attracted significant attention, particularly in the fields of optics and electronics. These resins exhibit low dielectric properties, low hygroscopicity, excellent transparency, and low refractive indices. Utilizing these materials as the main molecular backbone may further enhance the heat resistance and mechanical properties of the polymers.

Non-patent literature 1 discloses that known active cationic polymerization is divided into the following three major types:

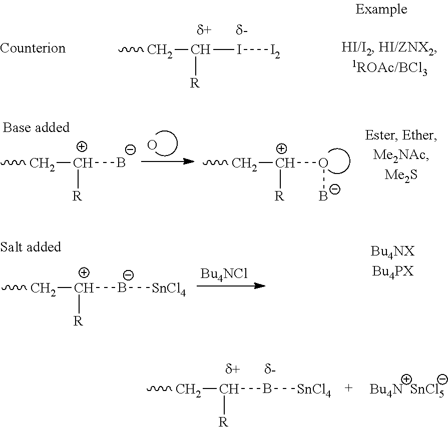

It is known that cationic polymerization of terpenes often uses AlCl₃ as the initiator, and water, hydrochloric acid, sulfuric acid, and chloroalkane as the ion source. Patent literature 1 (U.S. Pat. No. 9,790,301B2) uses AlCl₃ as the initiator, water as the ion source, chloromethane as the solvent, with a monomer weight ratio of isobutylene/alloocimene=10/1. The polymer yield is 86.12%, Mn is 293,000, and Tg is 74° C. Patent literature 2 (US2018/0079895A1) uses AlCl₃ as an initiator, trimethylchlorosilane as an ion source, xylene as a solvent, and α-pinene as a monomer. The softening point of the resultant polymer is 101.5° C., with a yield of 77.3%. Patent literature 3 (US2021/0309779A1) uses AlCl₃ as an initiator, sulfuric acid as an ion source, toluene as the solvent, and a monomer weight ratio of 1,3-cyclohexadiene/α-pinene=150/130. The resulting polymer has a softening point of 148° C., a Tg of 85° C., a molecular weight Mn of 638, an Mw of 1,319, and a yield of 79%.

Patent literature 4 (TWI706963B) discloses a soluble polyfunctional vinyl aromatic copolymer, which includes a polyfunctional vinyl aromatic copolymer derived from divinyl aromatic compounds and monovinyl aromatic compounds. The polymerization initiation system uses p-toluenesulfonic acid and butyl acetate as initiators, with toluene as a solvent, resulting in a copolymer with a molecular weight of Mn=740/Mw=3,470. However, the drawbacks include a relatively low molecular weight of the copolymer, significant branching, and insufficient adhesion to fine-line circuit substrates and low-roughness copper.

It may be seen from the above literature that cationic polymerization using trichloroaluminum and p-toluenesulfonic acid as initiators fails to achieve terpene polymers and linear divinyl aromatic copolymers of high molecular weight, low polydispersity index (PDI) and high yield, making it challenging to realize the ideal active cationic polymerization reaction.

From the perspective of environmental friendliness and environmental sustainability, polymers that replace traditional petrochemical monomers with bio-based terpenes may reduce CO₂ emissions. Terpene monomers derived from plants may be precisely controlled to tailor the molecular structure of polymers and introduce specific functional groups through cationic polymerization. This enhances the properties of polymers and copolymers, thereby expanding new industrial applications and increasing added value. Non-patent literature 1: Sadahito Aoshima and Shokyoku, J. Jpn. Soc. colour Mater., 82(2),76-88(2009)

### SUMMARY

The problem that the disclosure aims to solve is that in the prior art, in order to overcome the solubility problem of hyperbranched polydivinylbenzene, p-toluenesulfonic acid was adopted as an initiator to obtain a hyperbranched polydivinylbenzene oligomer. This oligomer exhibits issues with film-forming properties, adhesion, and heat resistance, and is unable to meet the requirements for fine lines on high-speed and high-frequency substrates, low roughness of the copper surface, and film thinning. Although hyperbranched polydivinylbenzene exhibits excellent dielectric properties, achieving the combination of low dielectric properties, adhesion, and flame retardancy in next-generation semiconductor packaging materials as well as high-speed and high-frequency substrates remains an unresolved issue.

In view of the aforementioned issues, the technical means by which this disclosure resolves such problems lies in the disclosure of an active cationic polymerization initiator composition. This composition initiates 1,1-dihydrocarbyl alkene monomers through a common ion complex, resulting in high molecular weight linear polymers. This improvement enhances film-forming properties, adhesion, and heat resistance. The polymer of this disclosure, through precise control, may achieve copolymers with specific molecular structures. These copolymers may utilize bio-based terpene monomers to enhance the anchor effect, thereby improving the adhesion on the copper foil surface. The use of 1,1-dihydrocarbyl alkene monomers provides stable cationic active chains, accelerates the chain propagation reaction, and increases the molecular weight of the polymer. Additionally, diisopropenylbenzene monomers are used to provide ethylene reactive functional groups, which may enhance the heat resistance of the cured material. The linear polymer with a high molecular weight obtained through the novel active cationic polymerization of this disclosure has excellent film-forming properties, adhesion, and heat resistance, which may replace the traditional hyperbranched low molecular weight polymers. In addition, a low dielectric reactive flame retardant is used to impart flame retardancy to hydrocarbon resin and polyphenylene ether resin.

In comparison with the efficacy of prior art, it is known that prior art utilizes p-toluenesulfonic acid as an initiator and acetate as a co-initiator, with divinylbenzene and ethylstyrene as monomers, resulting in a hyperbranched polymer with a molecular weight of approximately Mn=3000-4000. Although this polymer exhibits excellent dielectric properties, its hyperbranched molecular structure leads to poor adhesion to fine-line substrates and low-roughness copper foil surfaces, and also demonstrates poor film-forming properties. It is known that prior art uses aluminum chloride as an initiator and pinene as a monomer for cationic polymerization, and may only obtain polymers having a low molecular weight.

The disclosure discloses an active cationic polymerization initiator composition, which forms a common ion complex with trichloroaluminum, triphenylphosphine, and trihydrocarbyl chloromethane through a common ion effect. This composition initiates the polymerization of 1,1-dihydrocarbyl alkene monomers to form stable tertiary carbocations, thereby completing the initiation reaction. The copolymerization of diisopropenylbenzene monomers and terpene monomers or other comonomers may yield linear high molecular weight polymers with high yield and low polydispersity index (PDI). Furthermore, when co-cured with reactive flame retardants, the cured product exhibits properties such as flame retardancy, high heat resistance, low dissipation factor, low dielectric constant, adhesion, film-forming properties, etc., and may be applied to a high-speed and high-frequency substrate, a semi-cured film, an adhesive sheet, a thin film material, a semiconductor packaging material, an interlayer insulating film and other fields.

### DETAILED DESCRIPTION OF DISCLOSED EMBODIMENTS

The disclosure discloses a ternary diblock copolymer, which is copolymerized by the following monomers: (a) a diisopropenylbenzene monomer, (b) a terpene monomer from biomass, and (c) a 1,1-dihydrocarbyl alkene monomer. The chemical structure of the ternary diblock copolymer is poly(diisopropenylphenyl-1,1-dihydrocarbyl alkene)-polyterpene-poly(diisopropenylphenyl-1,1-dihydrocarbyl alkene). The diisopropenylbenzene includes: m-diisopropenylbenzene, p-diisopropenylbenzene, and o-diisopropenylbenzene. Commercially available diisopropenylbenzene is a mixture composed of approximately 71% m-diisopropenylbenzene, approximately 27% p-diisopropenylbenzene, and approximately 2% other monomers.

The disclosure discloses a ternary diblock copolymer, in which the terpene monomer derived from biomass is a general term for olefin compounds with isoprene repeating units (C₅H₈)ₙ. The terpenes containing a conjugated diene and not containing an aliphatic ring include β-myrcene, β-ocimene, alloocimene, farnesene, cosmene, etc. The terpenes containing both a conjugated diene and an aliphatic ring include α-phellandrene, β-phellandrene, α-terpinene, chamazulene, etc. The terpene that contains neither a conjugated diene nor an aliphatic ring includes isocitronellene. The terpenes containing an aliphatic ring and not containing a conjugated diene include α-pinene, β-pinene, camphene, β-terpinene, δ-terpinene, limonene, sabinene, humulene, β-caryophyllene, β-bisabolene, α-camphorene, longifolene, isolongifolene, valencene, and mixtures thereof. Commercially available limonene is a mixture containing 90% limonene and small amounts of β-myrcene, α-pinene, β-pinene, camphene, sabinene, β-phellandrene, carene, ocimene, valencene, farnesene, and cosmene. Commercially available β-pinene contains a mixture of small amounts of α-pinene, camphene, carene, limonene, δ-terpinene, longifolene, and β-caryophyllene. Commercial α-terpinene contains small amounts of β-terpinene. In a ternary diblock copolymer of this disclosure, in which for the terpene monomer derived from biomass, the most preferred compounds are α-terpinene and α-phellandrene (containing both a conjugated diene and an aliphatic ring terpene), β-myrcene (containing a conjugated diene and not containing an aliphatic ring), and camphene, β-pinene, and limonene (containing an aliphatic ring and not containing a conjugated diene), due to their relatively low cost and ease of acquisition. Listed below are some common terpenes suitable for the active cationic polymerization.

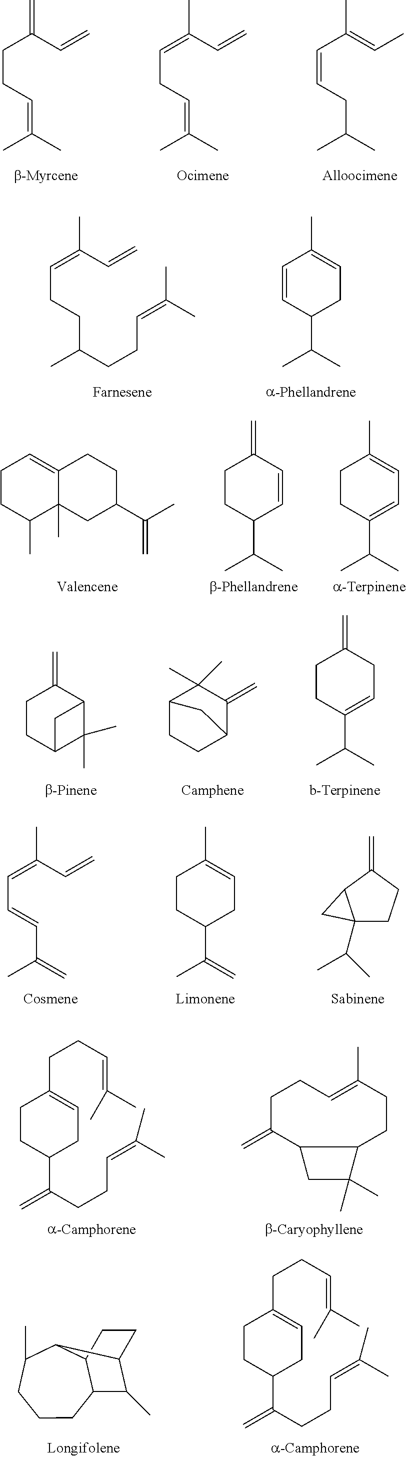

The disclosure discloses a ternary diblock copolymer, in which the 1,1-dihydrocarbyl alkene monomers include isobutylene, isoprene, disoprene, α-methylstyrene, 1,1-diphenylethylene, and 1,1-di-tolylethylene. The terpenes that, upon polymerization, may produce alicylic backbones include α-phellandrene, β-phellandrene, α-terpinene, β-pinene, etc. The terpenes that, upon polymerization, may produce alicylic pendent groups include limonene, camphene, sabinene, longifolene, α-camphorene, β-caryophyllene, β-terpinene, etc. Additionally, the terpenes containing a conjugated diene include β-myrcene, β-ocimene, alloocimene, farnesene, and cosmene, etc. The most preferred 1,1-dihydrocarbyl alkene includes α-methylstyrene, 1,1-diphenylethylene, β-pinene, α-phellandrene, α-terpinene, β-terpinene, limonene, camphene, and β-myrcene.

The disclosure discloses a ternary diblock copolymer having a chemical structure of poly(diisopropenylphenyl-1,1-dihydrocarbyl alkene)-polyterpene-poly(diisopropenylphenyl-1,1-dihydrocarbyl alkene). The polyterpene serves as the aliphatic chain segment, and the preferred terpenes include a-terpinene, α-phellandrene, β-phellandrene, camphene, β-pinene, sabinene, longifolene, limonene, β-myrcene, ocimene, alloocimene, and farnesene, with the most preferred being α-terpinene, α-phellandrene, camphene, β-pinene, and β-myrcene. When poly(diisopropenylphenyl-1,1-dihydrocarbyl alkene) is used as an aromatic or semi-aromatic rigid chain segment, the preferred 1,1-dihydrocarbyl alkene monomers include α-methylstyrene, 1,1-diphenylethylene, 1,1-di-tolylethylene, camphene, and limonene. The aromatic or semi-aromatic rigid chain segment and the flexible aliphatic chain segment of the ternary diblock copolymer may self-organize, and thus exhibit excellent film-forming properties. Diisopropenylbenzene can form a reactive isopropenylbenzene pendent group in poly(diisopropenylphenyl-1,1-dihydrocarbyl alkene), such that the ternary diblock copolymer has thermal curing properties, thereby obtaining the cured product with high heat resistance.

The disclosure discloses a ternary diblock copolymer, in which the chemical structure of the ternary diblock copolymer is poly(diisopropenylphenyl-1,1-dihydrocarbyl alkene)-polyterpene-poly(diisopropenylphenyl-1,1-dihydrocarbyl alkene). This ternary diblock copolymer may be obtained through an active cationic polymerization to yield the resulting ternary diblock copolymer. In active cationic polymerization, all molecular chains remain active after the monomers are consumed, and the propagation reaction may continue when new monomers are added. During active cationic polymerization, a mixture of diisopropenylbenzene and 1,1-dihydrocarbyl alkene, a terpene, and the mixture of diisopropenylbenzene and 1,1-dihydrocarbyl alkene are sequentially added in a segmented manner to obtain the ternary diblock copolymer.

Olefin monomers with electron-donating groups are generally capable of undergoing cationic polymerization. From the perspective of monomer structure, the methyl group in methyl ethylene monomers exhibits weak electron-donating properties, leading to a slower chain propagation rate. However, isobutylene, with its two methyl groups, increases the electron cloud density of the double bond, making it more prone to interaction with protons or cations, thus forming more stable tertiary carbocations and yielding polymers with higher molecular weight. Conjugated olefins have even stronger electron-donating properties than methyl groups. Nevertheless, in industrial applications, it is uncommon to use styrene, α-methylstyrene, butadiene, or isoprene as monomers for cationic polymerization. The hydrogen atoms on the methylene group in the growing chain of 1,1-diphenylethylene are protected by phenyl groups, making them less susceptible to abstraction. Stabling the carbocation can significantly reduce the occurrence of isomerization, rearrangement, disproportionation, chain transfer, and termination reactions. However, due to steric hindrance, the homopolymerization of 1,1-diphenylethylene is challenging, making it more prone to copolymerize with other monomers. This disclosure discovers that the homopolymerization of di-isoallylbenzene is rapid and tends to produce highly branched structures leading to gelation. However, by copolymerizing with an appropriate amount of other 1,1-dihydrocarbyl alkene monomers, the formation of branched structures may be inhibited, resulting in linear polymers while retaining the isoallylbenzene pendent group. 1,1-diphenylethylene, α-methylstyrene, and di-isoallylbenzene may produce ideal linear alternating copolymers.

The disclosure discloses an active cationic polymerization initiator composition, which includes at least: (a) trichloroaluminum, (b) triphenylphosphine, and (c) trihydrocarbyl chloromethane. This active cationic polymerization initiator composition initiates the polymerization of 1,1-dihydrocarbyl alkene monomers by forming a common ion complex through anhydrous trichloroaluminum, triphenylphosphine, and trihydrocarbyl chloromethane. Cationic polymerization is defined as an ionic polymerization in which the kinetic-chain carriers are cations. Generally, carbocations are unstable and are prone to chain transfer and termination reactions, often resulting in the production of oily substances with low molecular weight. The molecular weight of the polymer obtained by the cationic polymerization in the prior art is relatively lower than the molecular weight of the polymer obtained by the anionic polymerization. Generally, cationic polymerization is faster at low temperatures. If the chain transfer and termination reactions are inhibited, it may be referred to as active cationic polymerization. Active cationic polymerization is a chain-propagation polymerization initiated by a cationic initiator, which transfers a charge to the monomer, rendering the monomer reactive for polymerization. The monomer subsequently undergoes similar repetitive reactions with other monomers. Due to its selectivity towards specific monomers, this reaction allows for precise control over the polymer structure. Through the active cationic polymerization of the disclosure, the design of syndiotactic polymers, alternating polymers, and block polymers will become feasible.

Known cationic polymerization initiators include: monomers, ion sources, initiators, and co-initiators. In cationic polymerization, the monomers participating in the reaction must possess electron-donating substituents. These electron-donating substituents increase the electron cloud density of the double bond. The cationic active species attack the double bond of the monomer, forming a carbocation. The presence of the electron-donating substituents mitigates the electron cloud-deficient state of the carbon, thereby reducing the energy of the system and enhancing the stability of the carbocation. Common electron-donating substituents include methyl, phenyl, olefins, conjugated olefins, ether groups, amine groups, hydrocarbon groups, etc.

Known ion sources for cationic polymerization include: H₂O, ROH, HCl, and RCOOH that may release protons, and RCl, RCOCl, and R (CO₂)₂ that may release carbocations. Common initiators include protic acid and Lewis acid. Protic acids include: phosphoric acid, sulfuric acid, hydrochloric acid, trifluoromethanesulfonic acid, methylsulfonic acid, p-phenylmethylsulfonic acid, perchloric acid, CF₃COOH, CCl₃COOH, HI, and Lewis acid includes: BF₃, AlCl₃, AlCl₂R, AlClR₂, SnCl₄, TiCl₄, SbCl₅, PCl₅, ZnCl₂, POCl₃, CrO₂Cl, SOCl₂, VOCl₃, etc. Co-initiators are generally Lewis bases with nucleophilicity, including: ethers, esters, dimethyl sulfide, dimethyl vinyl amine, Bu₄NCl, Bu₄PCl, etc. The ion source and initiator react to produce cationic active species and counterions. The cationic active species transfers the charge to the monomers to generate carbocation, and finally forms a polymer. The intermediate complex formed by the counterion and the co-initiator may inhibit the tight bonding and covalent bond formation between counterions and carbocations. Cationic polymerization is highly sensitive to the solvent employed. The dissociative property of the solvent represents its ability to form free ions. The greater the number of free cationic active species, the faster the reactivity of the carbocation chain. Consequently, the solvent, monomer, ion source, initiator, and co-initiator must be mutually compatible to achieve high molecular weight polymers.

Active cationic polymerization is an ideal chain polymerization. In this type of polymerization, termination reaction and chain transfer reaction are inhibited, the initiation rate of the polymerization is significantly higher than the chain propagation rate, and the chain propagation rate is more stable compared to traditional polymerization. Each ion source generates a cationic active species, and each cationic active species is responsible for the polymerization of a polymer chain. The length of each polymer chain is similar, resulting in a narrow molecular weight distribution. Since the synthesis may be conducted in stages, it is possible to control the chain segments synthesized at different stages to have different monomers and specific functional groups. Therefore, block copolymers with predetermined molecular weights may be readily obtained. The basic reactions of active cationic polymerization are as shown in the following Formula 1 to Formula 4:

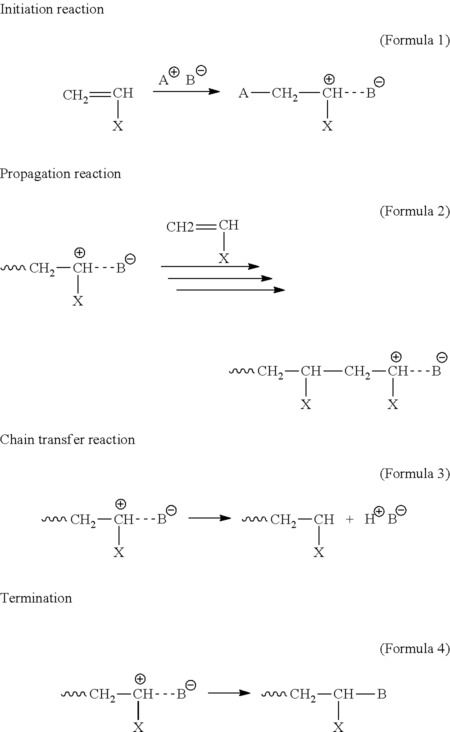

where A^{⊕} is a cationic active species, B^{⊖} is a counterion, and X is an electron-donating substituent.

The disclosure discloses an active cationic polymerization initiator composition, which includes at least: (a) trichloroaluminum, (b) triphenylphosphine, and (c) trihydrocarbyl chloromethane. The trichloroaluminum, the triphenylphosphine, and the trihydrocarbyl chloromethane form a common ion complex to initiate polymerization of 1,1-dihydrocarbyl alkene monomers. The active cationic polymerization initiator composition may effectively inhibit chain transfer reactions and termination reactions. The polymerization may proceed rapidly at a relatively low temperature range of −10° C. to 40° C., achieving a lower PDI (Mw/Mn) and high-yield, high-molecular-weight linear structured polymers compared to known active cationic polymerization, thereby realizing the ideal active cationic polymerization. Therefore, the high molecular weight linear structure polymers polymerized using the cationic polymerization initiator composition of this disclosure exhibit better film-forming properties and adhesion compared to the traditional low molecular weight branched structure polymers. Additionally, due to their inherent cross-linked curing properties, they may significantly enhance heat resistance.

The disclosure discloses an active cationic polymerization initiator composition, which includes an initiation reaction and a propagation reaction. Triphenylphosphine is a very weak Lewis base. The polymerization initiation reaction begins with the formation of a quaternary phosphonium salt from triphenylphosphine and trihydrocarbyl chloromethane in a non-polar or low-polarity solvent. The phosphonium cation core of this quaternary phosphonium salt is surrounded by three phenyl groups and the trihydrocarbyl methane. Due to spatial hindrance, the bonding distance between the phosphorus cation core and the Cl⁻ anion is relatively distant. Upon the addition of trichloroaluminum (AlCl₃), AlCl₄⁻ and a highly stable tertiary carbocation active species are formed. The tertiary carbocation active species and the phosphonium cation maintain a mutual stable balance among the anions Cl⁻ and AlCl₄⁻ through the common ion effect.

The active cationic polymerization initiator composition of this disclosure includes trichloroaluminum, triphenylphosphine, and trihydrocarbyl chloromethane, which form a common ion complex through their common ions. This complex initiates the polymerization of 1,1-dihydrocarbyl alkene monomers to form stable tertiary carbocations, completing the initiation reaction. Subsequently, the propagation reaction involves the repeated addition of 1,1-dihydrocarbyl alkene monomers, leading to the propagation of the molecular chain. The resulting stable tertiary carbocation chain inhibits termination reaction and chain transfer reaction from occurring. Traditional active cationic polymerization initiators may only achieve low molecular weight liquid terpene polymers. The active cationic polymerization initiator composition in this disclosure may achieve high molecular weight solid terpene polymers, possessing higher molecular weight, higher yield, and stereoselectivity compared to known active cationic polymerization initiators. The reaction mechanisms of the active cationic polymerization initiator composition of the disclosure are as shown in the following Formula 5 to Formula 8:

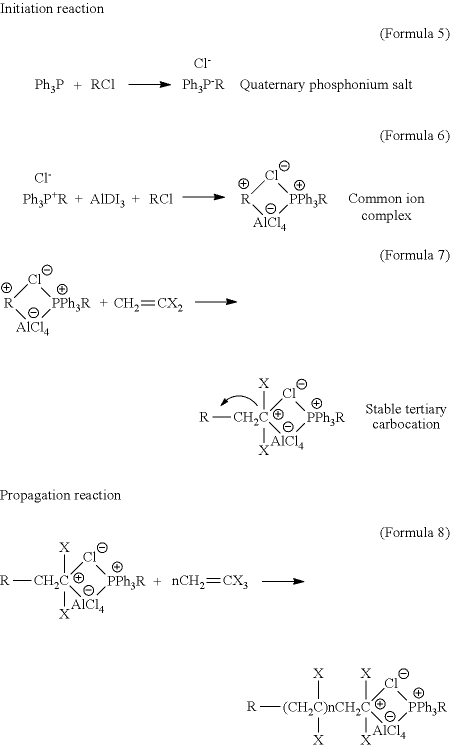

where RCl is trihydrocarbyl chloromethane, Ph₃P is triphenylphosphine, CH₂=CX₂ is 1,1-dihydrocarbyl alkene, and X is an electron-donating substituent.

The disclosure discloses an active cationic polymerization initiator composition. This initiation is generated through the mutual reaction of trichloroaluminum, triphenylphosphine, and trihydrocarbyl chloromethane, resulting in the formation of four common ions: R⁺, Cl⁻, AlCl₄⁻, and PhRP⁺. Due to the common ion effect, the dissociation degree and ion concentration may be effectively controlled. The four ions, R⁺, Cl⁻, AlCl₄⁻, and PhRP⁺, may form a common ion complex with a loosely spaced ion distance, which may stabilize the R+ carbocation active species. RCl includes: primary alkyl chloride, secondary alkyl chloride, benzyl chloride, tertiary alkyl chloride, triphenylmethyl chloride, 2-chloro-2-phenylisopropane, 2-methyl-2-chloropropane, trihydrocarbyl chloromethane, etc. The stability of the R+ carbocation formed is greatest in the tertiary carbocation. From the perspective of electron-donating substituent, the triphenyl carbocation exhibits greater stability than the trialkyl carbocation. The solvent used in the active cationic polymerization of the disclosure is preferably a non-graded solvent or a low-grade solvent, including toluene, xylene, trimethylbenzene, cyclohexane, methylcyclohexane, n-hexane, etc., and mixtures thereof. The common ion effect and the formation of the common ion complex are shown in the following Formula 9 to Formula 13.

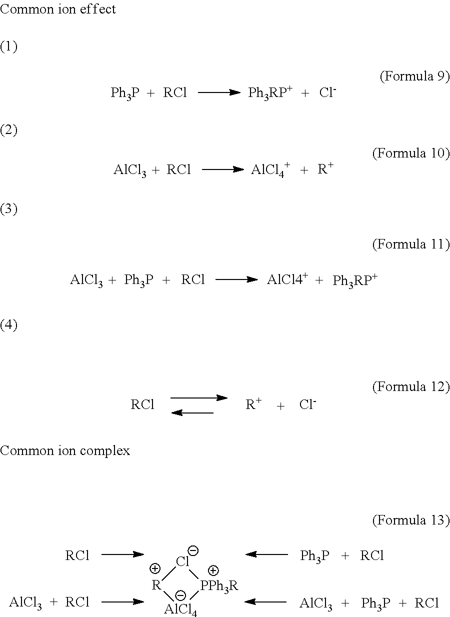

The disclosure discloses an active cationic polymerization initiator composition, in which 1,1-dihydrocarbyl alkene includes: isobutylene, isoprene, diisoprene, α-methylstyrene, 1,1-diphenylethylene, 1,1-di-tolylethylene, o-diisopropenylbenzene, m-diisopropenylbenzene, p-diisopropenylbenzene, limonene, α-terpinene, β-terpinene, camphene, β-pinene, β-myrcene, farnesene, ocimene, alloocimene, β-phellandrene, α-phellandrene, cosmene, β-caryophyllene, α-camphorene, longifolene, valencene, etc. For the initiation reaction of the active cationic polymerization, it is preferable to use α-methylstyrene, 1,1-diphenylethylene, 1,1-di-tolylethylene, β-pinene, α-terpinene, α-phellandrene, camphene, limonene, β-myrcene as the monomers.

The disclosure discloses a diisopropenylbenzene copolymer. The copolymer is obtained through a polymerization initiated by an active cationic polymerization initiator composition. The mole ratio of the diisopropenylbenzene monomer to the total monomers in the copolymer ranges from 5% to 65%. The monomers of the copolymer should have alpha electron-donating groups, which may help induce the initiation reaction and stabilize carbocations during chain propagation. The comonomers (A) of the diisopropenylbenzene copolymer include: monoolefins such as isobutylene, α-methylstyrene, 1,1-diphenylethylene, 1,1-di-tolylethylene; diolefins such as isoprene, diisoprene; terpenes such as α-terpinene, α-phellandrene, β-phellandrene, camphene, β-pinene, limonene, sabinene, longifolene, β-myrcene, ocimene, alloocimene, farnesene, cosmene, valencene, α-camphorene, and alkyl vinyl ether, N-vinylcarbazole, etc. The diisopropenylbenzene copolymers may be alternating copolymers, random copolymers, block copolymers, or graft copolymers. When the comonomer A is 1,1-diphenylethylene or 1,1-di-tolylethylene, it is preferable for diisopropenylbenzene (B) to constitute 50% of the total molar ratio of the monomers. Due to steric hindrance, comonomer A tends to have difficulty in homopolymerizing by itself, AB regular alternating copolymers may be formed. This alternating copolymer has high rigidity. When the comonomer A is α-methylstyrene, limonene, or camphene, isotactic polymers may be formed in which the isopropenylbenzene pendent groups are on the same side of the main chain. These isotactic polymers are characterized by high melting points and rapid crystallization properties. The isopropenylbenzene pendent groups within the chain segments significantly enhance the heat resistance after curing. If diisopropenylbenzene is used as the monomer for the initiation reaction, the monomer may generate carbocations at both ends for the initiation reaction. Consequently, the homopolymer of diisopropenylbenzene exhibits a highly branched structure, which leads to gelation during the polymerization process. However, if there are large adjacent groups on the isopropenylbenzene pendent groups, the steric hindrance may prevent the isopropenylbenzene pendent groups from being attacked by carbocations. Therefore, an appropriate ratio of diisopropenylbenzene and comonomer (A) may be employed to achieve the optimal yield of the diisopropenylbenzene copolymer.

The disclosure discloses a terpene polymer, which is obtained through a polymerization initiated by an active cationic polymerization initiator composition. The molar ratio of the terpene monomer to the total monomers in the terpene polymer ranges from 5% to 100%. The terpene monomers include: α-terpinene, α-phellandrene, β-phellandrene, camphene, β-pinene, limonene, sabinene, longifolene, β-myrcene, ocimene, alloocimene, farnesene, cosmene, valencene, and α-camphorene. These monomers exhibit copolymerization properties, allowing the formation of terpene and terpene copolymers, and copolymers of terpene and 1,1-dihydrocarbyl alkene. Among the terpene monomers, α-phellandrene, β-phellandrene, β-pinene, β-myrcene, ocimene, alloocimene, farnesene, and cosmene demonstrate excellent homopolymerization properties, achieving high molecular weight homopolymers or high molecular weight block copolymers unattainable by prior art.

The disclosure also discloses a flame-retardant resin composition, which at least includes: (a) a hydrocarbon resin, which includes at least one selected from the group consisting of: a ternary diblock copolymer, a diisopropenylbenzene copolymer, and a terpene polymer; and (b) a reactive flame retardant, which includes at least one selected from the group consisting of: 1,1-bis(diphenylphosphino)ethylene, 1,1-bis(diphenylphosphine oxide)ethylene, 3,3′-bis(diphenylphosphino)isobutylene, and 3,3′-bis(diphenylphosphine oxide)isobutylene. The chemical structures of reactive flame retardants are as follows:

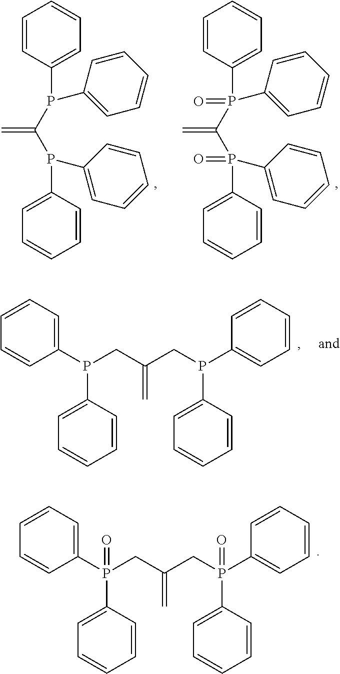

The disclosure discloses a flame-retardant resin composition, in which the reactive flame retardants 1,1-bis(diphenylphosphino)ethylene, 1,1-bis(diphenylphosphine oxide)ethylene,3,3′-bis(diphenylphosphino)isobutylene, or 3,3′-bis(diphenylphosphine oxide)isobutylene co-cures with hydrocarbon resin to form repeating units with symmetric polar groups. As a part of the co-cured product, the flame retardants do not degrade the original dielectric constant and dissipation factor of the hydrocarbon resin cured product, making them highly suitable as flame retardants for hydrocarbon resins and polyphenylene ethers with low dielectric properties. The reactive flame retardant is a polar molecule that is easily dissolved by solvents. After polymerization, the phosphorus structure-containing repeating units are symmetrical and low-polarity repeating units. Due to the steric hindrance of the large-volume symmetrical groups, the movement, vibration, and rotation of the molecular chains are reduced. Consequently, the dielectric constant and dissipation factor of the flame-retardant resin are minimally affected. This disclosure confirms that the polymerized reactive flame retardant exhibits properties of ultra-low dissipation factor.

1,1-bis(diphenylphosphino)ethylene and 3,3′-bis(diphenylphosphino)isobutylene are readily oxidized in air to 1,1-bis(diphenylphosphine oxide)ethylene and 3,3′-bis(diphenylphosphine oxide)isobutylene, respectively. Upon polymerization, their repeating units are also easily oxidized. These compounds may also serve as secondary antioxidants to reduce the oxidation of hydrocarbon resins. This is exemplified by the addition polymerization and oxidation of 1,1-bis(diphenylphosphino)ethylene, as illustrated in the following Formula 14.

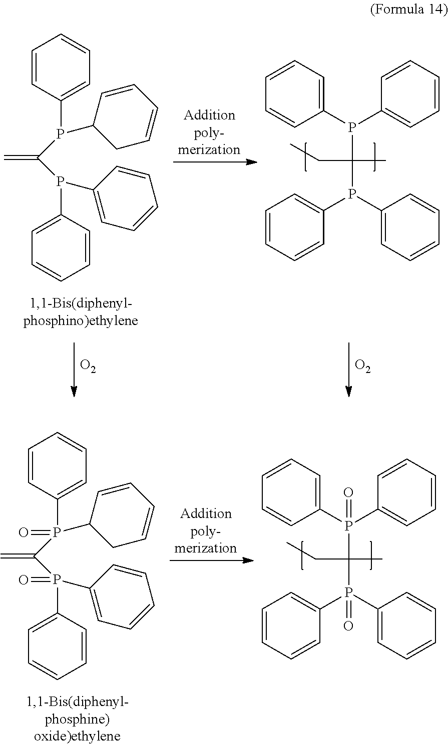

The disclosure discloses a flame-retardant resin composition, in which the hydrocarbon resin may be defined as a resin containing only carbon and hydrogen elements, including: styrene-containing aliphatic resins, styrene-containing alicyclic resins, styrene-containing aromatic resins, styrene-containing aliphatic-aromatic copolymer resins, styrene-containing hydrocarbon resins, α-methylstyrene-containing aliphatic resins, α-methylstyrene-containing alicyclic resins, α-methylstyrene-containing aromatic resins, α-methylstyrene-containing aliphatic-aromatic copolymer resins, α-methylstyrene-containing hydrocarbon resins, olefin-containing hydrocarbons, olefin-containing hydrocarbon resins, the ternary diblock copolymers of the disclosure, the diisopropenylbenzene copolymers of the disclosure, the terpene polymers of the disclosure, etc.

The disclosure discloses a flame-retardant resin composition, which may further include a modified polyphenylene ether, in addition to the reactive flame retardant. The modified polyphenylene ether includes methacrylic acid residue-containing polyphenylene ether, acrylic acid residue-containing polyphenylene ether, styrene group-containing polyphenylene ether, vinyl group-containing polyphenylene ether, and allyl group-containing polyphenylene ether, etc. The reactive flame retardant contributes flame retardancy to modified polyphenylene ether and does not degrade the original dielectric properties of the modified polyphenylene ether.

The disclosure also discloses a flame-retardant resin cured product, in which the chemical structure repeating unit of the resin cured product at least includes at least one selected from the group consisting of:

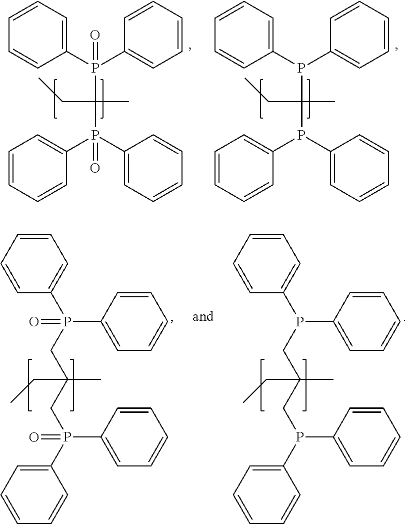

The flame-retardant resin cured product is obtained by co-curing at least one selected from the group consisting of olefin-containing compounds, olefin-containing resins, olefin-containing oligomers, styrene-containing compounds, styrene-containing resins, styrene-containing oligomers, α-methylstyrene-containing compounds, α-methylstyrene-containing resins, α-methylstyrene-containing oligomers, methacrylic acid residue-containing compounds, methacrylic acid residue-containing resins, methacrylic acid residue-containing oligomers, acrylic residue-containing compounds, acrylic residue-containing resins, and acrylic residue-containing oligomers with reactive flame retardants. The phosphorus content of this reactive flame retardant is higher than that of known additive-type phosphorus-based flame retardants. The reactive flame retardant may cure with ethylene-containing resins to form flame-retardant resin cured products, thereby achieving flame retardant effects. Furthermore, due to its high phosphorus content and reactivity, the amount of resin used may be significantly reduced. The reactive flame retardant used in the flame-retardant resin composition of this disclosure is superior to additive-type flame retardants.

The polymer used as an insulating material for high-speed and high-frequency substrates must possess properties such as a low dielectric constant (Dk) and low dissipation factor (Df). Insulating materials such as polyphenylene oxide (PPO) and hydrocarbon resin have been utilized in the field of high-speed and high-frequency substrates. However, due to their lack of flame retardancy, additional flame retardants need to be added. Existing additive-type low-dielectric flame retardants are not easily dissolved by solvents and are not miscible with the resin, making them unsuitable for fine-line and thinning processing.

The disclosure also discloses a semi-cured film, which includes the above-mentioned flame-retardant resin composition and the above-mentioned flame-retardant resin cured product. The disclosure also discloses a film, which includes the above-mentioned ternary diblock copolymer or the above-mentioned terpene polymer. The disclosure also discloses the use of a semi-cured film, which is used to manufacture a semiconductor packaging material, an IC carrier board, an adhesive sheet, an adhesive-backed copper foil, a high-speed and high-frequency substrate, or a printed circuit board. The disclosure also discloses the use of a film, which is used to manufacture semiconductor a packaging material, a build-up film, a redistribution layer, an interlayer insulating film, a sealing material, a cover film, or a flexible substrate. The disclosure also discloses the use of a flame-retardant resin cured product, which is used to manufacture a semiconductor packaging material, a high-speed and high-frequency substrate, or a printed circuit board.

Hereinafter, the disclosure will be described in detail with reference to embodiments. The following embodiments are provided to describe the disclosure. The scope of the disclosure includes the scope described in the following claims and their substitutions and modifications, and is not limited to the scope of the embodiments.

### Example 1 AD-T Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the reaction was continued for 0.5 hours. Then, 0.1468 mol/20 g of α-terpinene (abbreviated as T) was slowly added dropwise. After the addition was completed, the reaction was continued for 0.5 hours.

Next, a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene)-poly(α-terpinene)-poly(diisopropenylphenyl-1,1-diphenylethylene) ternary triblock copolymer (abbreviated as AD-T resin). The yield was 67.55%, the melting point Tm was measured to be 154° C., and the polydispersity index (PDI) measured by GPC was 35.13. The molar ratio of diisopropenylbenzene monomers to the total monomers constituting the ternary triblock copolymer was 41.5%, and the molar ratio of terpene monomers to the total monomers constituting the ternary triblock copolymer was 16.5%.

### Example 2 AD-C Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the reaction was continued for 0.5 hours. Then, 0.1468 mol/20 g of camphene (abbreviated as C) was slowly added dropwise. After the addition was completed, the reaction was continued for 0.5 hours. Next, a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene)-poly(camphene)-poly(diisopropenylphenyl-1,1-diphenylethylene) ternary triblock copolymer (abbreviated as AD-C resin). The yield was 61.17%, the melting point Tm was measured to be 153° C., and the polydispersity index (PDI) measured by GPC was 18.97. The molar ratio of diisopropenylbenzene monomers to the total monomers constituting the ternary triblock copolymer was 41.5%, and the molar ratio of terpene monomers to the total monomers constituting the ternary triblock copolymer was 16.5%.

### Example 3 AD-H Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the reaction was continued for 0.5 hours. Then, 0.1468 mol/20 g of α-phellandrene (abbreviated as H) was slowly added dropwise. After the addition was completed, the reaction was continued for 0.5 hours. Next, a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene)-poly(α-phellandrene)-poly(diisopropenylphenyl-1,1-diphenylethylene) ternary triblock copolymer (abbreviated as AD-H resin). The yield was 61.08%, the melting point Tm was measured to be 139° C., and the polydispersity index (PDI) measured by GPC was 7.72. The molar ratio of diisopropenylbenzene monomers to the total monomers is 41.5%, and the molar ratio of terpene monomers to the total monomers constituting the ternary triblock copolymer was 16.5%.

### Example 4 AD-P Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the reaction was continued for 0.5 hours. Then, 0.1468 mol/20 g of β-pinene (abbreviated as P) was slowly added dropwise. After the addition was completed, the reaction was continued for 0.5 hours. Next, a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene)-poly(β-pinene)-poly(diisopropenylphenyl-1,1-diphenylethylene) ternary triblock copolymer (abbreviated as AD-P resin). The yield was 66.30%, the melting point Tm was measured to be 141° C., and the polydispersity index (PDI) measured by GPC was 6.95. The molar ratio of diisopropenylbenzene monomers to the total monomers constituting the ternary triblock copolymer was 41.5%, and the molar ratio of terpene monomers to the total monomers constituting the ternary triblock copolymer was 16.5%.

### Example 5 AD-M Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the reaction was continued for 0.5 hours. Then, 0.1468 mol/20 g of β-myrcene (abbreviated as M) was slowly added dropwise. After the addition was completed, the reaction was continued for 0.5 hours. Next, a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene)-poly(β-myrcene)-poly(diisopropenylphenyl-1,1-diphenylethylene) ternary triblock copolymer (abbreviated as AD-M resin). The yield was 74.65%, the melting point Tm was measured to be 144° C., and the polydispersity index (PDI) measured by GPC was 1.36. The molar ratio of diisopropenylbenzene monomers to the total monomers constituting the ternary triblock copolymer was 41.5%, and the molar ratio of terpene monomers to the total monomers constituting the ternary triblock copolymer was 16.5%.

### Example 6 Aa-L Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1595 mol/25.3g of diisopropenylbenzene (abbreviated as A) and 0.3190 mol/37.7 g of α-methylstyrene (abbreviated as a) were slowly added dropwise. After the addition was completed, the reaction was continued for 0.5 hours. Then, 0.1468 mol/20 g of limonene (abbreviated as L) was slowly added dropwise. After the addition was completed, the reaction was continued for 0.5 hours. Next, a mixture of 0.1595 mol/25.3g of diisopropenylbenzene (abbreviated as A) and 0.3190 mol/37.7g α-methylstyrene (abbreviated as a) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-α-methylstyrene)-poly(limonene)-poly(diisopropenylphenyl-α-methylstyrene) ternary triblock copolymer (abbreviated as Aa-L resin). The yield was 60.17%, the melting point Tm was measured to be 156° C., and the polydispersity index (PDI) measured by GPC was 11.16. The molar ratio of diisopropenylbenzene monomers to the total monomers constituting the ternary triblock copolymer was 28.9%, and the molar ratio of terpene monomers to the total monomers constituting the ternary triblock copolymer was 13.2%.

### Example 7 AC-P Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1463 mol/23.15 g of diisopropenylbenzene (abbreviated as A) and 0.2925 mol/39.85 g of camphene (abbreviated as C) were slowly added dropwise. After the addition was completed, the reaction was continued for 0.5 hours. Then, 0.1468 mol/20 g of β-pinene (abbreviated as P) was slowly added dropwise. After the addition was completed, the reaction was continued for 0.5 hours. Next, a mixture of 0.1463 mol/23.15 g of diisopropenylbenzene (abbreviated as A) and 0.2925 mol/39.85 g camphene (abbreviated as C) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-camphene)-poly(β-pinene)-poly(diisopropenylphenyl-camphene) ternary triblock copolymer (abbreviated as AC-P resin). The yield was 85.10%, the melting point Tm was measured to be 141° C., and the polydispersity index (PDI) measured by GPC was 8.96. The molar ratio of diisopropenylbenzene monomers to the total monomers constituting the ternary triblock copolymer was 28.6%, and the molar ratio of terpene monomers to the total monomers constituting the ternary triblock copolymer was 71.4%.

### Example 8 AL-P Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.1463 mol/23.15 g of diisopropenylbenzene (abbreviated as A) and 0.2925 mol/39.85 g of limonene (abbreviated as L) were slowly added dropwise. After the addition was completed, the reaction was continued for 0.5 hours. Then, 0.1468 mol/20 g of β-pinene (abbreviated as P) was slowly added dropwise. After the addition was completed, the reaction was continued for 0.5 hours. Next, a mixture of 0.1463 mol/23.15 g of diisopropenylbenzene (abbreviated as A) and 0.2925 mol/39.85 g limonene (abbreviated as L) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-limonene)-poly(β-pinene)-poly(diisopropenylphenyl-limonene) ternary triblock copolymer (abbreviated as AL-P resin). The yield was 85.60%, the melting point Tm was measured to be 165° C., and the polydispersity index (PDI) measured by GPC was 22.90. The molar ratio of diisopropenylbenzene monomers to the total monomers constituting the ternary triblock copolymer was 28.6%, and the molar ratio of terpene monomers to the total monomers constituting the ternary triblock copolymer was 71.4%.

### Example 9 M01 Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and 1.0717 mol/146 g of β-myrcene (abbreviated as M) was slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(β-myrcene) (abbreviated as M01 resin). The yield was 88.34%, the melting point Tm was measured to be 143° C., and the polydispersity index (PDI) measured by GPC was 7.18. The molar ratio of terpene monomers to the total monomers constituting M01 resin was 100%.

### Comparative Example 1 M02 Synthesis

100 g of toluene and 9g of butyl acetate (abbreviated as BAc) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours. The temperature was controlled between 18° C. and 28° C. and 1.0717 mol/146 g of β-myrcene was slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(β-myrcene) (abbreviated as M02 resin). The yield was 46.57%, the melting point Tm was measured to be 12° C., and the polydispersity index (PDI) measured by GPC was 10.28.

### Comparative Example 2 ADM-S Synthesis

3.4 grams of 4-methylbenzenesulfonic acid (manufactured by Sigma-Aldrich, abbreviated as PTS), 100 grams of toluene, and 9 grams of butyl acetate were stirred and dissolved in a four-neck reaction flask equipped with mechanical stirring, a drying tube, a distillation receiver, and nitrogen at room temperature. The temperature was controlled between 18° C. and 28° C. and a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the reaction was continued for 0.5 hours. Then, 0.1468 mol/20 g of β-myrcene (abbreviated as M) was slowly added dropwise. After the addition was completed, the reaction was continued for 0.5 hours. Next, a mixture of 0.1862 mol/29.4 g of diisopropenylbenzene (abbreviated as A) and 0.1862 mol/33.6 g of 1,1-diphenylethylene (abbreviated as D) were slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene)-poly(β-myrcene)-poly(diisopropenylphenyl-1,1-diphenylethylene) ternary triblock copolymer (abbreviated as ADM-S resin). The yield was 41.57%, the melting point Tm was measured to be 56° C., and the polydispersity index (PDI) measured by GPC was 3.11.

TABLE 1

| | | | | | | | | | | | | Compar- | Compar- |
|---|---|---|---|---|---|---|---|---|---|---|---|---|---|
| | | | | | | | | | | | | ative | ative |
| | | | Exam- | Exam- | Exam- | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 | ple 9 | ple 1 | ple 2 |
| Resin | | | AD-T | AD-C | AD-H | AD-P | AD-M | Aa-L | AC-P | AL-P | M01 | M02 | ADM-S |
| Parts by | Initiator | AlCl₃ | 3.4 | 3.4 | 3.4 | 3.4 | 3.4 | 3.4 | 3.4 | 3.4 | 3.4 | 3.4 | — |
| weight | | TPC | 1.0 | 1.0 | 1.0 | 1.0 | 1.0 | 1.0 | 1.0 | 1.0 | 1.0 | — | — |
| | | TPP | 0.47 | 0.47 | 0.47 | 0.47 | 0.47 | 0.47 | 0.47 | 0.47 | 0.47 | — | — |
| | | PTS | — | — | — | — | — | — | — | — | — | — | 3.4 |
| | Monomer | A | 58.9 | 58.9 | 58.9 | 58.9 | 58.9 | 50.6 | 46.3 | 46.3 | — | — | 58.9 |
| | | D | 67.1 | 67.1 | 67.1 | 67.1 | 67.1 | — | — | — | — | — | 67.1 |
| | | a | — | — | — | — | — | 75.4 | — | — | — | — | — |
| | | T | 20.0 | — | — | — | — | — | — | — | — | — | — |
| | | H | — | — | 20.0 | — | — | — | — | — | — | — | — |
| | | C | — | 20.0 | — | — | — | — | 79.7 | — | — | — | — |
| | | P | — | — | — | 20.0 | — | — | 20.0 | 20.0 | — | — | — |
| | | L | — | — | — | — | — | 20.0 | — | 79.7 | — | — | — |
| | | M | — | — | — | — | 20 | — | — | — | 146 | 146 | 20.0 |
| | Solvent | TOL | 100 | 100 | 100 | 100 | 100 | 100 | — | — | 100 | 100 | 100 |
| | | BAc | — | — | — | — | — | — | — | — | — | 9 | 9 |

| | | | | | | | | | | | |
|---|---|---|---|---|---|---|---|---|---|---|---|
| Mn | 332 | 277 | 674 | 857 | 5418 | 853 | 957 | 990 | 3139 | 2004 | 1344 |
| Mw | 11668 | 5260 | 5208 | 5962 | 7364 | 9517 | 8575 | 22688 | 22531 | 20458 | 4178 |
| PDI | 35.13 | 18.97 | 7.72 | 6.95 | 1.36 | 11.16 | 8.96 | 22.9 | 7.18 | 10.28 | 3.11 |
| Yield (%) | 67.55 | 61.17 | 61.08 | 66.30 | 74.65 | 60.17 | 85.10 | 85.60 | 88.34 | 46.57 | 41.57 |
| Tm (° C.) | 154 | 153 | 139 | 141 | 144 | 156 | 141 | 165 | 143 | 12 | 56 |

### Example 10 AD Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.4313 mol/68.3 g of diisopropenylbenzene (abbreviated as A) and 0.4313 mol/77.7 g of 1,1-diphenylethylene (abbreviated as D) is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene) copolymer (abbreviated as AD resin). The yield was 73.23%, the melting point Tm was measured to be 170° C., and the polydispersity index (PDI) measured by GPC was 10.34. The molar ratio of diisopropenylbenzene monomers to the total monomers constituting AD resin was 50.0%.

### Example 11 AH Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.4958 mol/78.5 g of diisopropenylbenzene (abbreviated as A) and 0.4958 mol/67.5 g of α-phellandrene (abbreviated as H) is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-α-phellandrene) copolymer (abbreviated as AH resin). The yield was 74.99%, the melting point Tm was measured to be 198° C., and the polydispersity index (PDI) measured by GPC was 12.75. The molar ratio of diisopropenylbenzene monomers to the total monomers constituting AH resin was 50.0%, and the molar ratio of terpene monomers to the total monomers constituting AH resin was 50.0%.

### Example 12 AT Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.4958 mol/78.5 g of diisopropenylbenzene (abbreviated as A) and 0.4958 mol/67.5 g of α-terpinene (abbreviated as T) is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-α-terpinene) copolymer (abbreviated as AT resin). The yield was 68.69%, the melting point Tm was measured to be 199° C., and the polydispersity index (PDI) measured by GPC was 17.17. The molar ratio of diisopropenylbenzene monomers to the monomers constituting AT resin was 50.0%, and the molar ratio of terpene monomers to the total monomers constituting AT resin was 50.0%.

### Example 13 Aa Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.3697 mol/58.5 g of diisopropenylbenzene (abbreviated as A) and 0.7404 mol/87.5 g of α-methylstyrene (abbreviated as a) is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-α-methylstyrene) copolymer (abbreviated as Aa resin). The yield was 62.30%, the melting point Tm was measured to be 176° C., and the polydispersity index (PDI) measured by GPC was 27.35. The molar ratio of diisopropenylbenzene monomers to the total monomers constituting Aa resin was 33.3%.

### Example 14 AC Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.3697 mol/58.5 g of diisopropenylbenzene and 0.7404 mol/87.5 g of camphene is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-camphene) copolymer (abbreviated as AC resin). The yield was 69.80%, the melting point Tm was measured to be 258° C., and the polydispersity index (PDI) measured by GPC was 41.78. The molar ratio of diisopropenylbenzene monomers to the total monomers constituting AC resin is 33.3%, and the molar ratio of terpene monomers to the total monomers constituting AC resin was 66.7%.

### Example 15 AL Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.3697 mol/58.5 g of diisopropenylbenzene and 0.7404 mol/87.5 g of limonene is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-limonene) copolymer (abbreviated as AL resin). The yield was 89.04%, the melting point Tm was measured to be 201° C., and the polydispersity index (PDI) measured by GPC was 11.24. The molar ratio of diisopropenylbenzene monomers to the total monomers constituting AL resin was 33.3%, and the molar ratio of terpene monomers to the total monomers constituting AL resin was 66.7%.

### Example 16 AM Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.0815 mol/12.9 g of diisopropenylbenzene and 0.9770 mol/133.1 g of β-myrcene is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-β-myrcene) copolymer (abbreviated as AM resin). The yield was 66.05%, the melting point Tm was measured to be 20° C., and the polydispersity index (PDI) measured by GPC was 7.35. The molar ratio of diisopropenylbenzene monomers to the total monomers constituting AM resin was 7.7%, and the molar ratio of terpene monomers to the total monomers constituting AM resin was 92.3%.

### Example 17 AP Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and a mixture of 0.0815 mol/12.9 g of diisopropenylbenzene and 0.9770 mol/133.1 g of β-pinene is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-β-pinene) copolymer (abbreviated as AP resin). The yield was 95.89%, the melting point Tm was measured to be 143° C., and the polydispersity index (PDI) measured by GPC was 5.97. The molar ratio of diisopropenylbenzene monomers to the total monomers constituting AP resin was 7.7%, and the molar ratio of terpene monomers to the total monomers constituting AP resin was 92.3%.

### Example 18 MP Synthesis

1.79 mmol of triphenylphosphine (abbreviated as TPP, manufactured by Sigma-Aldrich), 3.59 mmol of triphenylmethyl chloride (abbreviated as TPC, manufactured by Sigma-Aldrich), and 100 g of toluene (abbreviated as TOL) were stirred and dissolved in a four-neck reaction flask equipped with mechanical stirring, a drying tube, a distillation receiver, and nitrogen at room temperature. Subsequently, 3.4 g of trichloroaluminum (manufactured by Sigma-Aldrich) was added and stirred at room temperature for 0.5 hours to produce a red common ion complex. The temperature was controlled between 18° C. and 28° C. and 0.2679 mol/36.5 g of β-myrcene was slowly added dropwise. After the addition was completed, the reaction was continued for 0.5 hours. Then, 0.5358 mol/73.0 g of β-pinene (abbreviated as P) was slowly added dropwise. After the addition was completed, the reaction was continued for 0.5 hours. Next, 0.2679 mol/36.5 g of β-myrcene was slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly β-myrcene-poly β-pinene-poly β-myrcene binary diblock copolymer (abbreviated as MP resin). The yield was 73.72%, the melting point Tm was measured to be 86° C., and the polydispersity index (PDI) measured by GPC was 6.81. The molar ratio of terpene monomers to the total monomers constituting MP resin was 100.0%.

### Comparative Example 3 AD-S Synthesis

100 grams of toluene and 9 grams of butyl acetate were stirred and dissolved in a four-neck reaction flask equipped with mechanical stirring, a drying tube, a distillation receiver, and nitrogen at room temperature. Subsequently, 3.4 g of p-toluenesulfonic acid was added and stirred at room temperature for 0.5 hours. The temperature was controlled between 18° C. and 28° C. and a mixture of 0.4313 mol/68.3 g of diisopropenylbenzene (abbreviated as A) and 0.4313 mol/77.7 g of 1,1-diphenylethylene (abbreviated as D) is slowly added dropwise. After the addition was completed, the temperature was controlled between 20° C. and 30° C. and the reaction was continued for 3 hours. Subsequently, methanol was added to precipitate the resin. The resin precipitate was washed with methanol for three times, washed with pure water for three times, and then dried under vacuum at 60° C. to obtain the poly(diisopropenylphenyl-1,1-diphenylethylene) copolymer (abbreviated as AD-S resin). The yield was 67.12%, the melting point Tm was measured to be 28° C., and the polydispersity index (PDI) measured by GPC was 12.6.

TABLE 2

| | | | | | | | | | | | | Compar- |
|---|---|---|---|---|---|---|---|---|---|---|---|---|
| | | | | | | | | | | | | ative |
| | | | Exam- | Exam- | Exam- | Exam- | Exam- | Exam- | Exam- | Exam- | Exam- | Exam- |
| | | | ple 10 | ple 11 | ple 12 | ple 13 | ple 14 | ple 15 | ple 16 | ple 17 | ple 18 | ple 3 |
| Resin | | | AD | AH | AT | Aa | AC | AL | AM | AP | MP | AD-S |
| Parts by | Initiator | AlCl₃ | 3.4 | 3.4 | 3.4 | 3.4 | 3.4 | 6.8 | 3.4 | 3.4 | 3.4 | 3.4 |
| weight | | TPC | 1.0 | 1.0 | 1.0 | 1.0 | 1.0 | 1.0 | 1.0 | 1.0 | 1.0 | — |
| | | TPP | 0.47 | 0.47 | 0.47 | 0.47 | 0.47 | 0.47 | 0.47 | 0.47 | 0.47 | — |
| | | PTS | — | — | — | — | — | — | — | — | — | 3.4 |
| | Monomer | A | 68.2 | 78.4 | 78.4 | 58.6 | 67.8 | 53.6 | 12.9 | 12.9 | — | 68.2 |
| | | D | 77.8 | — | — | — | — | — | — | — | — | 77.8 |
| | | a | — | — | — | 87.4 | — | — | — | — | — | — |
| | | T | — | — | 67.6 | — | — | — | — | — | — | — |
| | | H | — | 67.6 | — | — | — | — | — | — | — | — |
| | | C | — | — | — | — | 78.2 | — | — | — | — | — |
| | | P | — | — | — | — | — | — | — | 133.1 | 73 | — |
| | | L | — | — | — | — | — | 92.4 | — | — | — | — |
| | | M | — | — | — | — | — | — | 133.1 | — | 73 | — |
| | Solvent | TOL | 100 | 100 | 100 | 100 | 100 | 100 | 100 | 100 | 100 | 100 |
| | | BAc | — | — | — | — | — | — | — | — | — | 9 |

| | | | | | | | | | | |
|---|---|---|---|---|---|---|---|---|---|---|
| Mn | 972 | 2472 | 1824 | 453 | 720 | 1456 | 2243 | 2490 | 723 | 424 |
| Mw | 10057 | 31516 | 31327 | 12410 | 30096 | 16371 | 16498 | 14880 | 4925 | 5242 |
| PDI | 10.34 | 12.75 | 17.17 | 27.38 | 41.78 | 11.24 | 7.35 | 5.97 | 6.81 | 12.36 |
| Yield (%) | 73.23 | 74.99 | 68.68 | 62.30 | 69.80 | 89.04 | 66.05 | 95.89 | 73.72 | 67.12 |
| Tm (° C.) | 170 | 198 | 199 | 176 | 258 | 201 | 20 | 143 | 86 | 28 |

### Examples 19-27

100 grams of each of the resins AD-T, AD-C, AD-H, AD-P, AD-M, Aa-L, AC-P, AL-P, and M01 obtained from Examples 1 to 9 were respectively combined with 100 grams of toluene, 0.2 grams of an accelerant, and 0.1 grams of an antioxidant. The mixtures were homogenized to prepare an adhesive solution. This adhesive solution was applied to a heat-resistant glass plate and subjected to drying at 120° C. for 2 hours, 160° C. for 2 hours, and 180° C. for 2 hours, followed by baking at 220° C. for 4 hours, resulting in a cured product with a film thickness of 1.0 mm. The glass transition temperature, thermal decomposition temperature, dielectric constant (Dk), and dissipation factor (Df) of the cured product were measured. Additionally, the adhesive solution was applied onto a heat-resistant glass plate and subjected to drying at 120° C. for 2 hours, 160° C. for 2 hours, and 180° C. for 2 hours, followed by baking at 200° C. for 4 hours. This process yielded a cured product with a film thickness of 100 μm. The solvent resistance and film-forming properties were tested, and the data is presented in Table 3.

### Comparative Examples 4-5

100 grams of each of the resins M02 and ADM-S obtained from Comparative Examples 1 to 2 were respectively combined with 100 grams of toluene, 0.2 grams of an accelerant, and 0.1 grams of an antioxidant. The mixtures were homogenized to prepare an adhesive solution. This adhesive solution was applied to a heat-resistant glass plate and subjected to drying at 120° C. for 2 hours, 160° C. for 2 hours, and 180° C. for 2 hours, followed by baking at 220° C. for 4 hours, resulting in a cured product with a film thickness of 1.0 mm. The glass transition temperature, thermal decomposition temperature, dielectric constant (Dk), and dissipation factor (Df) of the cured product were measured. Additionally, the adhesive solution was applied onto a heat-resistant glass plate and subjected to drying at 120° C. for 2 hours, 160° C. for 2 hours, and 180° C. for 2 hours, followed by baking at 200° C. for 4 hours. This process yielded a cured product with a film thickness of 100 μm. The solvent resistance and film-forming properties were tested, and the data is presented in Table 3.

TABLE 3

| | | | | | | | | | | | | Compar- | Compar- |
|---|---|---|---|---|---|---|---|---|---|---|---|---|---|
| | | | | | | | | | | | | ative | ative |
| | | | Exam- | Exam- | Exam- | Exam- | Exam- | Exam- | Exam- | Exam- | Exam- | Exam- | Exam- |
| | | | ple 19 | ple 20 | ple 21 | ple 22 | ple 23 | ple 24 | ple 25 | ple 26 | ple 27 | ple 4 | ple 5 |
| Parts by | Resin | AD-T | 100 | — | — | — | — | — | — | — | — | — | — |
| weight | | AD-C | — | 100 | — | — | — | — | — | — | — | — | — |
| | | AD-H | — | — | 100 | — | — | — | — | — | — | — | — |
| | | AD-P | — | — | — | 100 | — | — | — | — | — | — | — |
| | | AD-M | — | — | — | — | 100 | — | — | — | — | — | — |
| | | Aa-L | — | — | — | — | — | 100 | — | — | — | — | — |
| | | AC-P | — | — | — | — | — | — | 100 | — | — | — | — |
| | | AL-P | — | — | — | — | — | — | — | 100 | — | — | — |
| | | M01 | — | — | — | — | — | — | — | — | 100 | — | — |
| | | M02 | — | — | — | — | — | — | — | — | — | 100 | — |
| | | ADM-S | — | — | — | — | — | — | — | — | — | — | 100 |

| | | | | | | | | | | | | |
|---|---|---|---|---|---|---|---|---|---|---|---|---|
| | Accelerant | 0.2 | 0.2 | 0.2 | 0.2 | 0.2 | 0.2 | 0.2 | 0.2 | 0.2 | 0.2 | 0.2 |
| | Antioxidant | 0.1 | 0.1 | 0.1 | 0.1 | 0.1 | 0.1 | 0.1 | 0.1 | 0.1 | 0.1 | 0.1 |
| Cured | Td3 | 274 | 309 | 292 | 287 | 285 | 279 | 276 | 273 | 298 | 219 | 272 |
| product | Tg | 100 | 121 | 109 | 92 | 93 | 163 | 164 | 175 | 149 | 88 | 54 |
| | Dk | 2.38 | 2.39 | 2.37 | 2.37 | 2.38 | 2.36 | 2.36 | 2.35 | 2.38 | 2.40 | 2.40 |
| | Df(×10⁻³) | 0.8 | 0.8 | 0.8 | 0.7 | 0.8 | 0.8 | 0.7 | 0.7 | 0.8 | 1.2 | 1.3 |
| | Film forming | ∘ | ∘ | ∘ | ∘ | ∘ | ∘ | ∘ | ∘ | ∘ | ▴ | ▴ |
| | property | | | | | | | | | | | |
| | Solvent | ∘ | ∘ | ∘ | ∘ | ∘ | ∘ | ∘ | ∘ | ∘ | ▴ | x |
| | resistance | | | | | | | | | | | |

### Examples 28-36

100 grams of each of the resins Aa, AD, AH, AT, AC, AL, AP, AM, and MP obtained from Examples 10 to 18 were respectively combined with 80 grams of toluene, 0.2 grams of an accelerant, and 0.1 grams of an antioxidant. The mixtures were homogenized to prepare an adhesive solution. This adhesive solution was applied to a heat-resistant glass plate and subjected to drying at 120° C. for 2 hours, 160° C. for 2 hours, and 180° C. for 2 hours, followed by baking at 220° C. for 4 hours, resulting in a cured product with a film thickness of 1.0 mm. The glass transition temperature, thermal decomposition temperature, dielectric constant (Dk), and dissipation factor (Df) of the cured product were measured. Additionally, the adhesive solution was applied onto a heat-resistant glass plate and subjected to drying at 120° C. for 2 hours, 160° C. for 2 hours, and 180° C. for 2 hours, followed by baking at 200° C. for 4 hours. This process yielded a cured product with a film thickness of 100μm. The solvent resistance and film-forming properties were tested, and the data is presented in Table 4.

### Comparative Example 6

100 grams of the resin AD-S from Comparative Example 3 were combined with 100 grams of toluene, 0.2 grams of an accelerant, and 0.1 grams of an antioxidant. The mixture was homogenized to prepare an adhesive solution. This adhesive solution was applied to a heat-resistant glass plate and subjected to drying at 120° C. for 2 hours, 160° C. for 2 hours, and 180° C. for 2 hours, followed by baking at 220° C. for 4 hours, resulting in a cured product with a film thickness of 1.0 mm. The glass transition temperature, thermal decomposition temperature, dielectric constant (Dk), and dissipation factor (Df) of the cured product were measured. Additionally, the adhesive solution was applied onto a heat-resistant glass plate and subjected to drying at 120° C. for 2 hours, 160° C. for 2 hours, and 180° C. for 2 hours, followed by baking at 200° C. for 4 hours. This process yielded a cured product with a film thickness of 100 μm. The solvent resistance and film-forming properties were tested, and the data is presented in Table 4.

TABLE 4

| | | | | | | | | | | | | Compar- |
|---|---|---|---|---|---|---|---|---|---|---|---|---|
| | | | | | | | | | | | | ative |
| | | | Exam- | Exam- | Exam- | Exam- | Exam- | Exam- | Exam- | Exam- | Exam- | Exam- |
| | | | ple 28 | ple 29 | ple 30 | ple 31 | ple 32 | ple 33 | ple 34 | ple 35 | ple 36 | ple 6 |
| Parts by | Resin | AD | 100 | — | — | — | — | — | — | — | — | — |
| weight | | AH | — | 100 | — | — | — | — | — | — | — | — |
| | | AT | — | — | 100 | — | — | — | — | — | — | — |
| | | Aa | — | — | — | 100 | — | — | — | — | — | — |
| | | AC | — | — | — | — | 100 | — | — | — | — | — |
| | | AL | — | — | — | — | — | 100 | — | — | — | — |
| | | AM | — | — | — | — | — | — | 100 | — | — | — |
| | | AP | — | — | — | — | — | — | — | 100 | — | — |
| | | MP | — | — | — | — | — | — | — | — | 100 | — |
| | | AD-S | — | — | — | — | — | — | — | — | — | 100 |

| | | | | | | | | | | | |
|---|---|---|---|---|---|---|---|---|---|---|---|
| | Accelerant | 0.2 | 0.2 | 0.2 | 0.2 | 0.2 | 0.2 | 0.2 | 0.2 | 0.2 | 0.2 |
| | Antioxidant | 0.1 | 0.1 | 0.1 | 0.1 | 0.1 | 0.1 | 0.1 | 0.1 | 0.1 | 0.1 |
| Cured | Td3 | 306 | 305 | 289 | 309 | 316 | 290 | 293 | 291 | 282 | 282 |
| product | Tg | 127 | 155 | 157 | 112 | 201 | 159 | 129 | 100 | 145 | 55 |
| | Dk | 2.35 | 2.35 | 2.35 | 2.36 | 2.36 | 2.26 | 3.36 | 2.35 | 2.35 | 2.41 |
| | Df(×10⁻³) | 0.8 | 0.8 | 0.8 | 1.0 | 0.8 | 0.8 | 0.8 | 0.7 | 0.7 | 1.2 |
| | Film forming | ∘ | ∘ | ∘ | ∘ | ▴ | ∘ | ∘ | ∘ | ∘ | x |
| | property | | | | | | | | | | |
| | Solvent | ∘ | ∘ | ∘ | ∘ | ∘ | ∘ | ∘ | ∘ | ∘ | x |
| | resistance | | | | | | | | | | |

### Examples 37-45

50 grams of each of the resins AD-T, AD-C, AD-H, AD-P, AD-M, Aa-L, AC-P, AL-P, and M01 obtained from Examples 1 to 9 were respectively combined with 50 grams of PPE resin, 80 grams of toluene, 18 grams of flame retardant, 0.2 grams of an accelerant, and 0.1 grams of an antioxidant. The mixtures were homogenized to prepare an adhesive solution. E-glass fiber cloths were impregnated with the respective adhesive solutions and were then dried at 155° C. for 5 minutes to obtain respective prepreg fabrics. Subsequently, low roughness copper foil (HVLP2) was covered on 8 surfaces of the respective prepreg fabrics, and cured at a temperature of 220° C. and a pressure of 3.0 Mpa to obtain a copper-clad substrate. The glass transition temperature (Tg), thermal decomposition temperature (Td3), dielectric constant (Dk), dissipation factor (Df), flame retardancy, and copper foil peel strength were measured, with the data presented in Table 5.

### Comparative Examples 7-8

80g of toluene, 0.2 g of an accelerant, and 0.1 g of an antioxidant were respectively added to two 100 g portions of PPE. Additionally, in one of the portions (Comparative Example 7), 18 g of a flame retardant was added, whereas in the other portion (Comparative Example 8), no flame retardant was added. The mixtures were homogenized to prepare an adhesive solution. E-glass fiber cloths were impregnated with the respective adhesive solutions and were then dried at 155° C. for 5 minutes to obtain respective prepreg fabrics. Subsequently, low roughness copper foil (HVLP2) was covered on 8 surfaces of the respective prepreg fabrics, and cured at a temperature of 220° C. and a pressure of 3.0 Mpa to obtain a copper-clad substrate. The glass transition temperature (Tg), thermal decomposition temperature (Td3), dielectric constant (Dk), dissipation factor (Df), flame retardancy, and copper foil peel strength were measured, with the data presented in Table 5.

TABLE 5

| | | | | | | | | | | | | Compar- | Compar- |
|---|---|---|---|---|---|---|---|---|---|---|---|---|---|
| | | | | | | | | | | | | ative | ative |
| | | | Exam- | Exam- | Exam- | Exam- | Exam- | Exam- | Exam- | Exam- | Exam- | Exam- | Exam- |
| | | | ple 37 | ple 38 | ple 39 | ple 40 | ple 41 | ple 42 | ple 43 | ple 44 | ple 45 | ple 7 | ple 8 |
| Parts by | Resin | AD-T | 50 | — | — | — | — | — | — | — | — | — | — |
| weight | | AD-C | — | 50 | — | — | — | — | — | — | — | — | — |
| | | AD-H | — | — | 50 | — | — | — | — | — | — | — | — |
| | | AD-P | — | — | — | 50 | — | — | — | — | — | — | — |
| | | AD-M | — | — | — | — | 50 | — | — | — | — | — | — |
| | | Aa-L | — | — | — | — | — | 50 | — | — | — | — | — |
| | | AC-P | — | — | — | — | — | — | 50 | — | — | — | — |
| | | AL-P | — | — | — | — | — | — | — | 50 | — | — | — |
| | | M01 | — | — | — | — | — | — | — | — | 50 | — | — |
| | | PPE | 50 | 50 | 50 | 50 | 50 | 50 | 50 | 50 | 50 | 100 | 100 |

| | | | | | | | | | | | | |
|---|---|---|---|---|---|---|---|---|---|---|---|---|
| | Accelerant | 0.2 | 0.2 | 0.2 | 0.2 | 0.2 | 0.2 | 0.2 | 0.2 | 0.2 | 0.2 | 0.2 |
| | Antioxidant | 0.1 | 0.1 | 0.1 | 0.1 | 0.1 | 0.1 | 0.1 | 0.1 | 0.1 | 0.1 | 0.1 |
| | Flame | — | — | — | — | — | — | — | 18 | — | — | — |
| | retardant A | | | | | | | | | | | |
| | Flame | 18 | 18 | 18 | 18 | 18 | — | — | — | 18 | 18 | — |
| | retardant B | | | | | | | | | | | |
| | Flame | — | — | — | — | — | 18 | — | — | — | — | — |
| | retardant C | | | | | | | | | | | |
| | Flame | — | — | — | — | — | — | 18 | — | — | — | — |
| | retardant D | | | | | | | | | | | |
| Cured | Td3 | 279 | 271 | 261 | 264 | 267 | 273 | 292 | 300 | 294 | 305 | 312 |
| product | Tg | 141 | 155 | 125 | 130 | 135 | 122 | 145 | 150 | 168 | 165 | 168 |
| | Dk | 3.07 | 3.06 | 3.06 | 3.06 | 3.6 | 3.08 | 3.09 | 3.07 | 3.08 | 3.08 | 3.07 |
| | Df(×10⁻³) | 1.2 | 1.1 | 1.0 | 1.0 | 1.1 | 1.3 | 1.0 | 1.3 | 1.2 | 1.6 | 1.8 |
| | UL-94 | V-0 | V-0 | V-0 | V-0 | V-0 | V-0 | V-0 | V-0 | V-0 | V-1 | NG |
| | Copper peel | 0.79 | 0.85 | 0.88 | 0.89 | 0.80 | 0.92 | 0.99 | 0.87 | 0.96 | 0.86 | 0.85 |
| | strength N/mm | | | | | | | | | | | |

### Examples 46-54

50 grams of each of the resins AD, AH, AT, Aa, AC, AL, AP, AM, and MP obtained from Examples 10 to 18 were respectively combined with 50 grams of PPE resin, 80 grams of toluene, 18 grams of flame retardant, 0.2 grams of an accelerant, and 0.1 grams of an antioxidant.

The mixtures were homogenized to prepare an adhesive solution. E-glass fiber cloths were impregnated with the respective adhesive solutions and were then dried at 155° C. for 5 minutes to obtain respective prepreg fabrics. Subsequently, low roughness copper foil (HVLP2) was covered on 8 surfaces of the respective prepreg fabrics, and cured at a temperature of 220° C. and a pressure of 3.0 Mpa to obtain a copper-clad substrate. The glass transition temperature (Tg), thermal decomposition temperature (Td3), dielectric constant (Dk), dissipation factor (Df), flame retardancy, and copper foil peel strength were measured, with the data presented in Table 6.

### Comparative Example 9

80g of toluene, 18 g of flame retardant, 0.2 g of an accelerant, and 0.1 g of an antioxidant were added to 100 g of AD resin. The mixture was homogenized to prepare an adhesive solution. E-glass fiber cloth was impregnated with the adhesive solution and was then dried at 155° C. for 5 minutes to obtain a prepreg fabric. Subsequently, low roughness copper foil (HVLP2) was covered on the surfaces of eight pieces of the prepreg fabric, which was then cured at a temperature of 220° C. and a pressure of 3.0 Mpa to obtain a copper-clad substrate. The glass transition temperature (Tg), thermal decomposition temperature (Td3), dielectric constant (Dk), dissipation factor (Df), flame retardancy, and copper foil peel strength were measured, with the data presented in Table 6.

### Comparative Example 10

50 grams of PPE resin, 80 g of toluene, 18 g of flame retardant, 0.2 g of an accelerant, and 0.1 g of an antioxidant were added to 50 grams of PDVB (hyperbranched polydivinylbenzene resin/manufactured by Nippon Steel Corporation). The mixture was homogenized to prepare an adhesive solution. E-glass fiber cloth was impregnated with the adhesive solution and was then dried at 155° C. for 5 minutes to obtain a prepreg fabric. Subsequently, low roughness copper foil (HVLP2) was covered on the surfaces of eight pieces of the prepreg fabric, which was then cured at a temperature of 220° C. and a pressure of 3.0 Mpa to obtain a copper-clad substrate. The glass transition temperature (Tg), thermal decomposition temperature (Td3), dielectric constant (Dk), dissipation factor (Df), flame retardancy, and copper foil peel strength were measured, with the data presented in Table 6.

TABLE 6

| | | | | | | | | | | | | Compar- | Compar- |
|---|---|---|---|---|---|---|---|---|---|---|---|---|---|
| | | | | | | | | | | | | ative | ative |
| | | | Exam- | Exam- | Exam- | Exam- | Exam- | Exam- | Exam- | Exam- | Exam- | Exam- | Exam- |
| | | | ple 46 | ple 47 | ple 48 | ple 49 | ple 50 | ple 51 | ple 52 | ple 53 | ple 54 | ple 9 | ple 10 |
| Parts by | Resin | AD | 50 | — | — | — | — | — | — | — | — | 100 | — |
| weight | | AH | — | 50 | — | — | — | — | — | — | — | — | — |
| | | AT | — | — | 50 | — | — | — | — | — | — | — | — |
| | | Aa | — | — | — | 50 | — | — | — | — | — | — | — |
| | | AC | — | — | — | — | 50 | — | — | — | — | — | — |
| | | AL | — | — | — | — | — | 50 | — | — | — | — | — |
| | | AM | — | — | — | — | — | — | 50 | — | — | — | — |
| | | AP | — | — | — | — | — | — | — | 50 | — | — | — |
| | | MP | — | — | — | — | — | — | — | — | 50 | — | — |
| | | PPE | 50 | 50 | 50 | 50 | 50 | 50 | 50 | 50 | 50 | — | 50 |
| | | PDVB | — | — | — | — | — | — | — | — | — | — | 50 |

| | | | | | | | | | | | | |
|---|---|---|---|---|---|---|---|---|---|---|---|---|
| | Accelerant | 0.2 | 0.2 | 0.2 | 0.2 | 0.2 | 0.2 | 0.2 | 0.2 | 0.2 | 0.2 | 0.2 |
| | Antioxidant | 0.1 | 0.1 | 0.1 | 0.1 | 0.1 | 0.1 | 0.1 | 0.1 | 0.1 | 0.1 | 0.1 |
| | Flame | — | — | — | — | — | — | — | — | 18 | — | — |
| | retardant A | | | | | | | | | | | |
| | Flame | 18 | 18 | 18 | 18 | 18 | 18 | — | — | — | 18 | 18 |
| | retardant B | | | | | | | | | | | |
| | Flame | — | — | — | — | — | — | 18 | — | — | — | — |
| | retardant C | | | | | | | | | | | |
| | Flame | — | — | — | — | — | — | — | 18 | — | — | — |
| | retardant D | | | | | | | | | | | |
| Cured | Td3 (° C.) | 302 | 309 | 298 | 290 | 309 | 300 | 293 | 297 | 297 | 307 | 306 |
| product | Tg (° C.) | 144 | 173 | 167 | 141 | 171 | 182 | 150 | 94 | 132 | 128 | 148 |
| | Dk | 3.06 | 3.05 | 3.07 | 3.06 | 3.07 | 3.06 | 3.07 | 3.08 | 3.07 | 3.04 | 3.06 |
| | Df(×10⁻³) | 1.1 | 1.0 | 1.1 | 1.0 | 1.1 | 1.0 | 1.4 | 1.2 | 1.3 | 0.8 | 1.8 |
| | UL-94 | V-0 | V-0 | V-0 | V-0 | V-0 | V-0 | V-0 | V-0 | V-0 | V-0 | V-0 |
| | Copper peel | 0.75 | 0.76 | 0.72 | 0.74 | 0.68 | 0.78 | 0.92 | 0.97 | 1.09 | 0.70 | 0.61 |
| | strength (N/mm) | | | | | | | | | | | |

Diisopropenylbenzene (abbreviated as A, purity 99.0%, manufactured by Deltech), α-methylstyrene (abbreviated as a, purity 99.0%, manufactured by Thermo), 1,1-diphenylethylene (abbreviated as D, purity 99.0%, manufactured by TCI), α-terpinene (abbreviated as T, purity 95.0%, manufactured by Sigma-Aldrich), α-phellandrene (abbreviated as H, purity 95.0%, manufactured by Sigma-Aldrich), camphene (abbreviated as C, purity 90.0%, manufactured by Sigma-Aldrich), β-pinene (abbreviated as P, purity 99.0%, manufactured by Thermo), limonene (abbreviated as L, purity 96.0%, manufactured by Thermo), β-myrcene (abbreviated as M, purity 90.0%, manufactured by Thermo).

Flame retardant A: 1,1-bis(diphenylphosphino)ethylene, manufactured by Sigma-Aldrich, flame retardant B: 1,1-bis(diphenylphosphine oxide)ethylene, manufactured by INNOPHARMCHEM, flame retardant C: 3,3′-bis(diphenylphosphino)isobutylene, manufactured by Chinyee, flame retardant D: 3,3′-bis(diphenylphosphine oxide)isobutylene, manufactured by Chinyee.

Modified polyphenylene ether (abbreviated as: PPE): terminal styrene-modified polyphenylene ether/trade name: OPE-2st 2200/manufactured by Mitsubishi Gas Chemical.

Accelerant (trade name: BC-90): 2,3-dimethyl-2,3-diphenylbutane/manufactured by NOF.

Antioxidant (trade name: AO-60): pentaerythritol tetrakis[3-(3,5-di-tert-butyl-4-hydroxyphenyl)propionate]/manufactured by ADEKA.

Glass transition temperature (Tg): a differential scanning calorimetry (DSC) manufactured by TA Instruments is used to measure the maximum peak temperature, with units in ° C.

Thermal decomposition temperature (Td3): a Q500 thermogravimetric analyzer (TGA) manufactured by TA Instruments is used for measurements. 3% thermogravimetric loss/5% thermogravimetric loss is expressed as temperature with units in° C.

Dielectric constant (Dk): measured at a frequency of 10 GHz using a resonant cavity manufactured by AGILENT Technologies.

Dissipation factor (Df): measured at a frequency of 10 GHz using a resonant cavity manufactured by AGILENT Technologies.

Flame retardancy UL-94: According to the UL-94 flame retardant standard, the vertical burning test method is used. Test specimens measure 127 mm in length and 12.5 mm in width. The classifications are as follows: V-2, V-1, and V-0, with V-0 being the highest flame retardant rating.

Film-forming properties: the adhesive solution was applied on the glass plate and its appearance and flatness were inspected after drying and curing.
○: Indicating that the surface is very flat;
▴: Indicating that the surface is somewhat uneven;
x: Indicating that the film is broken.

Solvent resistance: the film was soaked in methyl ethyl ketone (MEK) for 1 hour and the appearance was inspected afterwards.
○: Indicating no change;
▴: Indicating expansion;
x: Indicating cracking and dissolution.

To sum up, as shown in Table 1, the melting point Tm of M01 resin (Tm=143° C.) is greater than the melting point Tm of M02 resin (Tm=12° C.), which means that the crystallinity of M01 resin is higher than that of M02 resin. The melting point Tm of AD-M resin (Tm=144° C.) is greater than the melting point Tm of ADM-S resin (Tm=56° C.), which means that the crystallinity of AD-M resin is higher than that of ADM-S resin. As shown in Table 2, the melting point Tm of AD resin (Tm=170° C.) is greater than the melting point Tm of AD-S resin (Tm=28° C.), which means that the crystallinity of AD resin is higher than that of AD-S resin. From the above, it may be seen that the polymers synthesized using the active cationic polymerization initiator composition of this disclosure exhibit higher “tacticity” in their molecular chains compared to those synthesized using trichloroaluminum or p-toluenesulfonic acid. It has been confirmed that the polymerization employing the active cationic polymerization initiator composition of this disclosure demonstrates high “stereoselectivity,” resulting in polymers with higher physical heat resistance.

As shown in Table 1, the yield of M01 resin is 88.34%, which is greater than the yield of M02 resin at 46.57%. The yield of AD-M resin is 74.65%, which is greater than the yield of ADM-S resin at 41.57%. As shown in Table 2, the yield of AD resin is 73.23%, which is greater than the yield of AD-S resin at 67.12%, indicating that the termination reaction is inhibited when the active cationic polymerization initiator composition of this disclosure is used for polymerization. As shown in Table 1, the PDI (Mw/Mn) of M01 resin is 7.18, which is less than the PDI (Mw/Mn) of M02 resin at 10.28. The PDI (Mw/Mn) of AD-M resin is 1.36, which is less than the PDI (Mw/Mn) of ADM-S resin at 3.11. As shown in Table 2, the PDI (Mw/Mn) of AD resin is 10.34, which is less than the PDI (Mw/Mn) of AD-S resin at 12.36, indicating that the chain transfer reaction is inhibited when the active cationic polymerization initiator composition of this disclosure is used for polymerization. This confirms that the employed polymerization of the disclosure is an ideal active cationic polymerization. The reaction environment formed by the active cationic polymerization initiator composition of the disclosure is better than that formed by traditional initiators such as trichloroaluminum or p-toluenesulfonic acid.

As shown in Table 3, the Td3 of M01 resin is 298° C., which is greater than the Td3 of M02 resin at 219° C., and the Tg of M01 resin is 149° C., which is greater than the Tg of M02 resin at 88° C. Additionally, the Td3 of AD-M resin is 285° C., which is greater than the Td3 of ADM-S resin at 272° C., and the Tg of AD-M resin is 93° C., which is greater than the Tg of ADM-S resin at 54° C. Furthermore, as shown in Table 4, the Td3 of AD resin is 306° C., which is greater than the Td3 of AD-S resin at 282° C., and the Tg of AD resin is 127° C., which is greater than the Tg of AD-S resin at 55° C. This indicates that, in terms of the chemical heat resistance of polymers, the active cationic polymerization initiator composition in this disclosure is better than the traditional initiators such as trichloroaluminum or p-toluenesulfonic acid.

The film-forming properties of the ternary diblock copolymers AD-T, AD-C, AD-H, AD-P, AD-M, Aa-L, AC-P, AL-P, and the M01 resin are better than those of M02 and ADM-S, indicating that polymers using the active cationic polymerization initiator composition of the disclosure exhibit excellent film-forming properties. The ternary diblock copolymers may self-organize, offering advantages in the preparation of ultra-thin films. M01, AD-M, and AD resins exhibit better solvent resistance compared to M02, ADM-S, and AD-S. This indicates that the active cationic polymerization initiator composition employed in this disclosure may maintain a more complete olefin group, so the resin cured product has good solvent resistance.

As shown in Table 1, the Tm of the M01 resin is 143° C., which is greater than the Tm of the M02 resin at 12° C. The molecular weight of the MO1 resin is greater than the molecular weight of the M02 resin. It may be inferred that the M01 resin obtained from the active cationic polymerization initiator composition of this disclosure is a solid terpene homopolymer, which is significantly different from the M02 resin obtained from traditional polymerization, which is a liquid terpene homopolymer. In addition, as shown in Table 2, MP resin, with a Tm of 86° C., is also a solid terpene and terpene copolymer.

As shown in Table 5, the flame retardancy of the resin cured products of AD-T, AD-C, AD-H, AD-P, AD-M, Aa-L, AC-P, AL-P, M01 resin, and PPE mixture with added flame retardants may be enhanced from V-1 to V-0 without degrading the original Df properties. As shown in Table 5, the flame retardancy of the cured product of AD resin with added flame retardants may reach V-O without degrading the original Df properties. As shown in Table 5, the flame retardancy of the cured products of AD-T, AD-C, AD-H, AD-P, AD-M, Aa-L, AC-P, AL-P, M01 resin, and PPE mixture with added flame retardants may reach V-0, with Df lower than the cured product of PPE with added flame retardant, confirming that AD-T, AD-C, AD-H, AD-P, AD-M, Aa-L, AC-P, AL-P and M01 resin are novel ultra-low dielectric resins. As shown in Table 6, the flame retardancy of the cured products of AD, AH, AT, Aa, AC, AL, AM, AP, MP resin, and PPE mixture with added flame retardants may reach V-0, with Df lower than the cured product of PPE with added flame retardant, confirming that AD, AH, AT, Aa, AC, AL, AM, AP, and MP resin are novel ultra-low dielectric resins. Flame retardants have low dielectric and flame retardancy.

As shown in Table 5, the copper peel strength of the cured products of AD-T, AD-C, AD-H, AD-P, AD-M, Aa-L, AC-P, AL-P, M01 resin, and PPE mixture with added flame retardants and the cured products of AD, AH, AT, Aa, AC, AL, AM, AP, MP resin, and PPE mixture with added flame retardants are better than the mixture of PDVB (hyperbranched polydivinylbenzene) and PPE, confirming that the adhesion of the resin of the disclosure is better than that of PDVB of prior art.

As may be seen from the above, the disclosure discloses an active cationic polymerization initiator composition, which forms a common ion complex with trichloroaluminum, triphenylphosphine, and trihydrocarbyl chloromethane through a common ion effect. This composition initiates the polymerization of 1,1-dihydrocarbyl alkene monomers to form stable tertiary carbocations, thereby completing the initiation reaction. The copolymerization of diisopropenylbenzene monomers and terpene monomers or other comonomers may yield linear high molecular weight polymers with high yield and low polydispersity index (PDI). Furthermore, when co-cured with reactive flame retardants, the produced cured product exhibits properties such as flame retardancy, high heat resistance, low dissipation factor, low dielectric constant, adhesion, and/or film-forming properties, and may be used in a high-speed and high-frequency substrate, a semi-cured film, an adhesive sheet, a thin film material, a semiconductor packaging material, an interlayer insulating film and other fields.

The disclosure has been described with reference to the above-mentioned specific examples and comparative examples. Those with ordinary knowledge in the technical field to which this disclosure belongs will be able to make various changes based on the above descriptions, which does not limit the claimed scope of the disclosure.

What is claimed is:

1. A ternary diblock copolymer, copolymerized from following monomers: (a) diisopropenylbenzene, (b) a terpene from biomass, and (c) a 1,1-dihydrocarbyl alkene, wherein a chemical structure of the ternary diblock copolymer is poly(diisopropenylphenyl-1,1-dihydrocarbyl alkene)-polyterpene-poly(diisopropenylphenyl-1,1-dihydrocarbyl alkene).

2. An active cationic polymerization initiator composition, comprising: (a) trichloroaluminum; (b) triphenylphosphine; and (c) trihydrocarbyl chloromethane, wherein the trichloroaluminum, the triphenylphosphine, and the trihydrocarbyl chloromethane form a common ion complex to initiate polymerization of 1,1-dihydrocarbyl alkene monomers.

3. A diisopropenylbenzene copolymer, obtained through polymerization of diisopropenylbenzene monomers initiated by the active cationic polymerization initiator composition according to claim 2, wherein a mole ratio of the diisopropenylbenzene monomers to the total monomers constituting the diisopropenylbenzene copolymer is 5% to 65%.

4. A terpene polymer, obtained through polymerization of terpene monomers initiated by the active cationic polymerization initiator composition according to claim 2, wherein a mole ratio of the terpene monomers to the total monomers constituting the terpene polymer is 5% to 100%.

5. A flame-retardant resin composition, comprising: (a) the ternary diblock copolymer according to claim 1; and (b) a reactive flame retardant, comprising at least one selected from the group consisting of 1,1-bis(diphenylphosphino)ethylene, 1,1-bis(diphenylphosphine 3,3′-bis(diphenylphosphino)isobutylene, and 3,3′-bis(diphenylphosphine oxide)ethylene, oxide)isobutylene.

6. A flame-retardant resin composition, comprising: (a) the diisopropenylbenzene copolymer according to claim 3; and (b) a reactive flame retardant, comprising at least one selected from the group consisting of 1,1-bis(diphenylphosphino)ethylene, 1,1-bis(diphenylphosphine oxide)ethylene, 3,3′-bis(diphenylphosphino)isobutylene, and 3,3′-bis(diphenylphosphine oxide)isobutylene.

7. A flame-retardant resin composition, comprising: (a) the terpene polymer according to claim 4; and (b) a reactive flame retardant, comprising at least one selected from the group consisting of 1,1-bis(diphenylphosphino)ethylene, 1,1-bis(diphenylphosphine oxide)ethylene, 3,3′-bis(diphenylphosphino)isobutylene, and 3,3′-bis(diphenylphosphine oxide)isobutylene.

8. The flame-retardant resin composition according to claim 7, further comprising a modified polyphenylene ether.

9. A flame-retardant resin cured product formed from the flame-retardant resin composition according to claim 5, wherein a chemical structure repeating unit of the flame-retardant resin cured product comprises at least one selected from the group consisting of

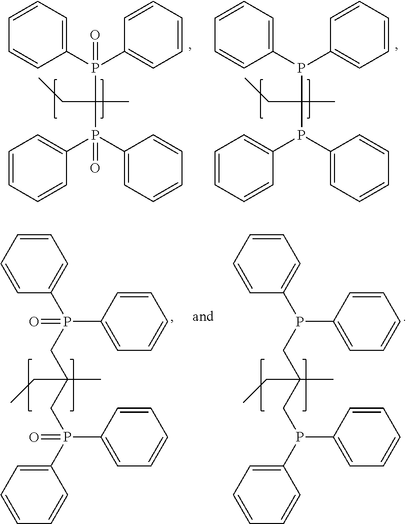

10. A flame-retardant resin cured product formed from the flame-retardant resin composition according to claim 7, wherein a chemical structure repeating unit of the flame-retardant resin cured product comprises at least one selected from the group consisting of

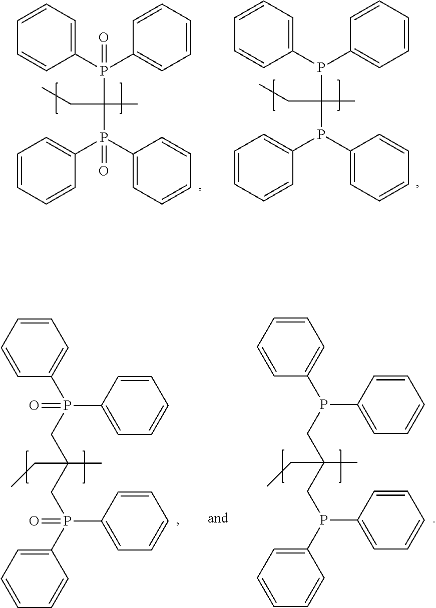

11. A flame-retardant resin cured product formed from the flame-retardant resin composition according to claim 8, wherein a chemical structure repeating unit of the flame-retardant resin cured product comprises at least one selected from the group consisting of

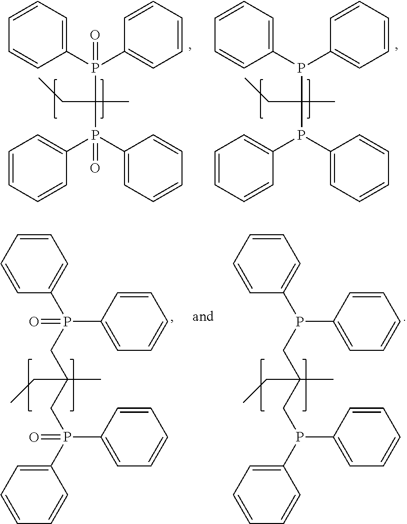

12. A semi-cured film, comprising the flame-retardant resin cured product according to claim 11.

13. A film, comprising the ternary diblock copolymer according to claim 1.

14. A film, comprising the terpene polymer according to claim 4.

15. A use of the semi-cured film according to claim 12, in fabrication of a semiconductor packaging material, an IC carrier board, an adhesive sheet, an adhesive-backed copper foil, a high-speed and high-frequency substrate, or a printed circuit board.

16. A use of the film according to claim 13, in fabrication of a semiconductor packaging material, a build-up film, a redistribution layer, an interlayer insulating film, a sealing material, a cover film, or a flexible substrate.

17. A use of the film according to claim 14, in fabrication of a semiconductor packaging material, a build-up film, a redistribution layer, an interlayer insulating film, a sealing material, a cover film, or a flexible substrate.

18. A use of the flame-retardant resin cured product according to claim 9, in fabrication of a semiconductor packaging material, a high-speed and high-frequency substrate, or a printed circuit board.

19. A use of the flame-retardant resin cured product according to claim 10, in fabrication of a semiconductor packaging material, a high-speed and high-frequency substrate, or a printed circuit board.

20. A use of the flame-retardant resin cured product according to claim 11, in fabrication of a semiconductor packaging material, a high-speed and high-frequency substrate, or a printed circuit board.
